(19) United States
(12) Patent Application Publication
(10) Pub. No.: US 2026/0056550 A1
(43) Pub. Date: Feb. 26, 2026

(54) CONVEYANCE APPARATUS AND CONVEYANCE CONTROL APPARATUS

(71) Applicant: Isuzu Motors Limited, Yokohama-shi (JP)

(72) Inventors: Tomoaki SHIMOZAWA, Fujisawa-shi (JP); Maya MATSUSHITA, Fujisawa-shi (JP); Yuka MIZUSHI, Fujisawa-shi (JP); Masato GOKAN, Fujisawa-shi (JP)

(73) Assignee: Isuzu Motors Limited, Yokohama-shi (JP)

(21) Appl. No.: 19/290,482

(22) Filed: Aug. 5, 2025

(30) Foreign Application Priority Data
Aug. 22, 2024 (JP) 2024-140785

(51) Int. Cl. G05D 1/49; B66F 9/065; B66F 9/075; G01M 1/12; G05D 105/28

(52) U.S. Cl. CPC G05D 1/498; B66F 9/065; B66F 9/0755; G01M 1/122; G05D 2105/28

(57) ABSTRACT

Provided is a conveyance apparatus that includes: a lifting mechanism raisable upward and lowerable downward, lifts an object to be conveyed, by bringing the lifting mechanism into contact with the object to be conveyed and raising the lifting mechanism, and moves in a state in which the object to be conveyed is lifted. The conveyance apparatus includes: a plurality of load sensors that is provided in the lifting mechanism and each detects a load received by coming into contact with the object to be conveyed; a calculation section that calculates a center-of-gravity position of the object to be conveyed, based on a distribution of a plurality of the loads that has been detected; and a control section that causes the conveyance apparatus to move to a position, at which the object to be conveyed is liftable at the calculated center-of-gravity position, and causes the lifting mechanism to be raised.

### RELATED APPLICATIONS

This application claims the benefit of priority of Japanese Patent Application No. 2024-140785, filed on Aug. 22, 2024, the contents of which are incorporated by reference as if fully set forth herein in their entirety.

### TECHNICAL FIELD

The present disclosure relates to a conveyance apparatus and a conveyance control apparatus.

### BACKGROUND ART

In the related art, a conveyance apparatus that lifts and conveys an object to be conveyed has been used in a factory, a warehouse, and the like (for example, see Patent Literature (hereinafter referred to as “PTL”) 1). As the conveyance apparatus, for example, an automatic guided vehicle (AGV) and an autonomous mobile robot (AMR) are known.

### CITATION LIST

### Patent Literature

### PTL 1

Japanese Patent Application Laid-Open No. 2023-136060

### SUMMARY OF INVENTION

### Technical Problem

In the conveyance apparatus in the related art, there is a problem in that an object to be conveyed is inclined or falls down in a case where the object to be conveyed is lifted at a position deviating from the center-of-gravity position thereof.

An object of an aspect of the present disclosure is to provide a conveyance apparatus and a conveyance control apparatus each capable of more surely preventing inclination or fall down of an object to be conveyed when the object to be conveyed is lifted.

### Solution to Problem

A conveyance apparatus according to an aspect of the present disclosure is a conveyance apparatus that includes a lifting mechanism raisable upward and lowerable downward, lifts an object to be conveyed, by bringing the lifting mechanism into contact with the object to be conveyed and raising the lifting mechanism, and moves in a state in which the object to be conveyed is lifted. The conveyance apparatus includes: a plurality of load sensors that is provided in the lifting mechanism and each detects a load received by coming into contact with the object to be conveyed; a calculation section that calculates a center-of-gravity position of the object to be conveyed, based on a distribution of a plurality of the loads that has been detected; and a control section that causes the conveyance apparatus to move to a position, at which the object to be conveyed is liftable at the center-of-gravity position that has been calculated, and causes the lifting mechanism to be raised.

A conveyance control apparatus according to an aspect of the present disclosure is a conveyance control apparatus that is provided separately from a conveyance apparatus and controls the conveyance apparatus, where the conveyance apparatus includes a lifting mechanism raisable upward and lowerable downward, lifts an object to be conveyed, by bringing the lifting mechanism into contact with the object to be conveyed and raising the lifting mechanism, and moves in a state in which the object to be conveyed is lifted. The conveyance control apparatus includes: a communication section that receives load information, which indicates a plurality of loads detected by a plurality of load sensors provided in the lifting mechanism when the plurality of load sensors comes into contact with the object to be conveyed, from the conveyance apparatus and transmits control information, which indicates a control instruction for the conveyance apparatus, to the conveyance apparatus; a calculation section that calculates a center-of-gravity position of the object to be conveyed, based on a distribution of the plurality of loads that has been detected; and a control section that generates the control information for moving the conveyance apparatus to a position, at which the object to be conveyed is liftable at the center-of-gravity position that has been calculated, and raising the lifting mechanism.

### Advantageous Effects of Invention

According to the present disclosure, it is possible to more surely prevent inclination or fall down of an object to be conveyed when the object to be conveyed is lifted.

### BRIEF DESCRIPTION OF DRAWINGS

FIG. 1 is a side view schematically illustrating a conveyance apparatus and an object to be conveyed according to an embodiment of the present disclosure;

FIG. 2 is a top view schematically illustrating a plane portion of a lifting mechanism according to the embodiment of the present disclosure;

FIG. 3 is a block diagram illustrating the configuration of the conveyance apparatus according to the embodiment of the present disclosure;

FIG. 4 is a flowchart illustrating operations of the conveyance apparatus according to the embodiment of the present disclosure;

FIG. 5 is a side view schematically illustrating a state in which the lifting mechanism of the conveyance apparatus is in contact with the object to be conveyed according to the embodiment of the present disclosure;

FIG. 6 is a top view schematically illustrating the center position, centroid lines, and the center-of-gravity position in the plane portion of the lifting mechanism according to the embodiment of the present disclosure; and

FIG. 7 is a block diagram illustrating the configurations of a conveyance apparatus and a conveyance control apparatus according to a variation of the present disclosure.

### DESCRIPTION OF EMBODIMENTS

Hereinafter, an embodiment of the present disclosure will be described with reference to the accompanying drawings.

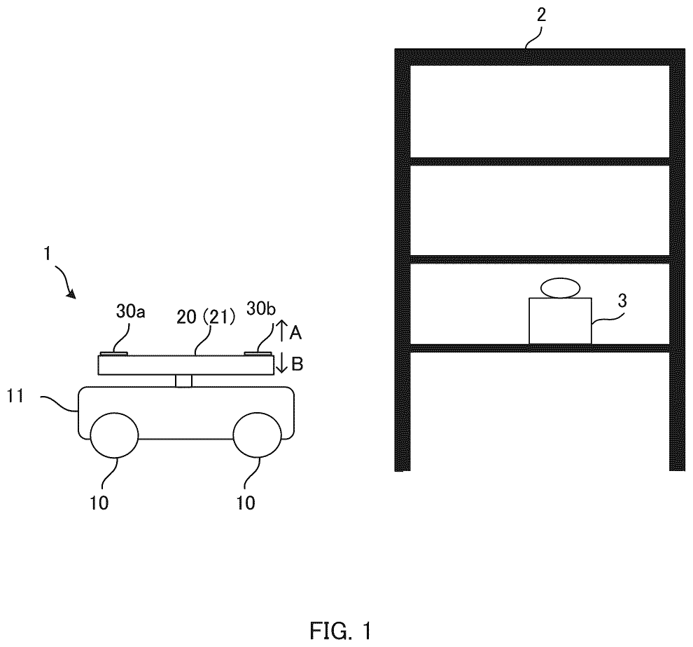

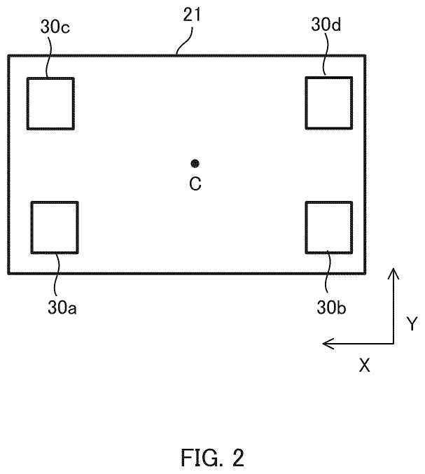

First, outlines of conveyance apparatus 1 and object to be conveyed 2 in the present embodiment will be described using FIGS. 1 and 2.

FIG. 1 is a side view schematically illustrating conveyance apparatus 1 and object to be conveyed 2. Object to be conveyed 2 is an object that is conveyed by conveyance apparatus 1. Examples of object to be conveyed 2 include an instrument (for example, a rack, a pallet, a box, or the like) which allows one or more objects to be disposed at any position(s) and of which the center-of-gravity position varies depending on the number and position(s) of the object(s). In the present embodiment, a case where object to be conveyed 2 is a rack including a plurality of shelves will be described as an example.

Note that, in the present embodiment, a case where one cargo 3 is disposed on the lowest shelf of object to be conveyed 2 as illustrated in FIG. 1 will be described as an example, but the number and position(s) of cargo(s) 3 disposed in object to be conveyed 2 are not limited to those illustrated in FIG. 1.

Conveyance apparatus 1 is an apparatus that is capable of lifting object to be conveyed 2, by bringing lifting mechanism 20 (whose details will be described later) into contact with object to be conveyed 2 and raising lifting mechanism 20, and is capable of moving to a predetermined position in a state in which object to be conveyed 2 is lifted. Examples of conveyance apparatus 1 include an AMR or an AGV as described above. As illustrated in FIG. 1, conveyance apparatus 1 includes body portion 11, a

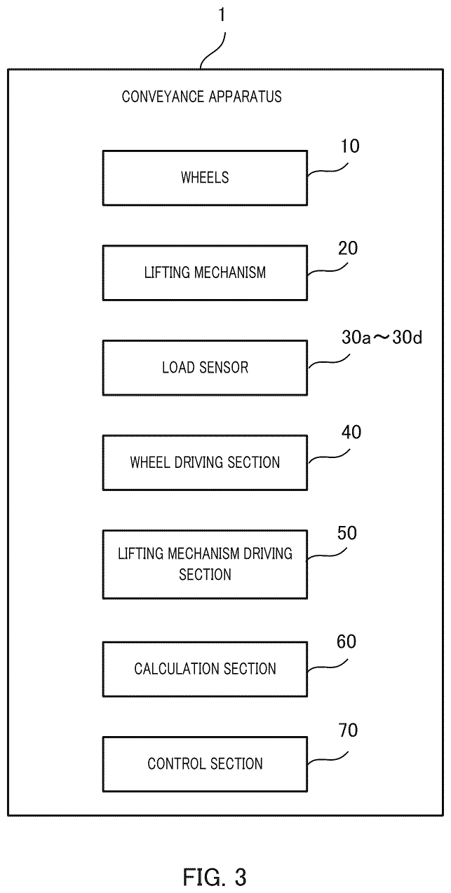

plurality of wheels 10, and lifting mechanism 20. In addition, although illustration is omitted in FIG. 1, wheel driving section 40, lifting mechanism driving section 50, calculation section 60, and control section 70 (see FIG. 3) all of which will be described later are provided inside body portion 11.

The plurality of wheels 10 is provided below body portion 11. Conveyance apparatus 1 is capable of moving (traveling) in each of the forward, rearward, leftward, and rightward directions by control of the rotation direction and/or steering direction of wheels 10.

Lifting mechanism 20 is provided above body portion 11. Lifting mechanism 20 is raisable and lowerable, upward and downward, respectively (in the directions of arrows A and B in FIG. 1). Plane portion 21 parallel to the ground (not illustrated) on which wheels 10 are placed is provided on an upper section of lifting mechanism 20.

Plane portion 21 illustrated in FIG. 1 is in a state of being lowered to the lowest position (hereinafter referred to as the most lowered state). Plane portion 21 can be raised in the direction of arrow A in FIG. 1 from the most lowered state. In addition, plane portion 21 can be lowered in the direction of arrow B in FIG. 1 from the raised state to return to the most lowered state.

FIG. 2 is a top view schematically illustrating plane portion 21 of lifting mechanism 20. As illustrated in FIG. 2, the shape of plane portion 21 as viewed from directly above is rectangular. In FIG. 2, the X direction indicates the longitudinal direction of plane portion 21, the Y direction indicates the lateral direction of plane portion 21, and center position C indicates the center position of plane portion 21 (an example of the center position of lifting mechanism 20).

As illustrated in FIG. 2, plane portion 21 is provided with load sensors 30a, 30b, 30c, and 30d that are disposed to be apart from each other. In addition, as illustrated in FIG. 1, load sensors 30a to 30d are provided to protrude from plane portion 21 (in FIG. 1, illustration of load sensors 30c and 30d is omitted).

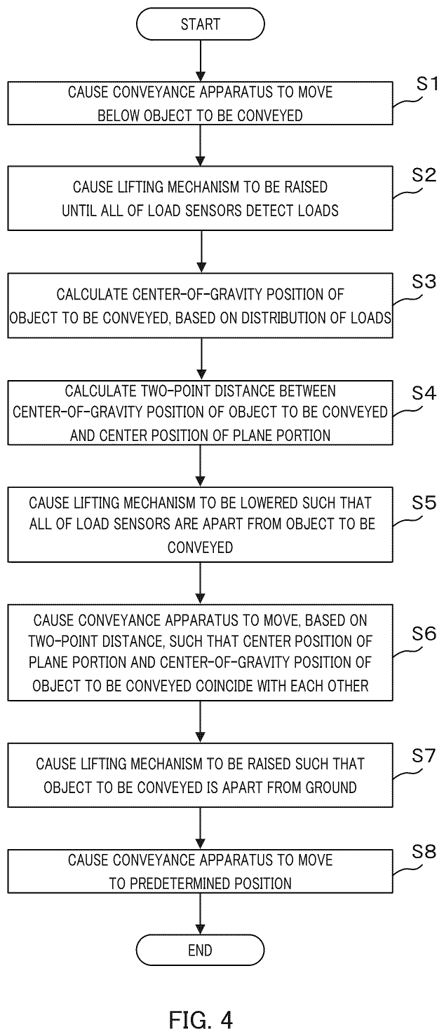

Each of load sensors 30a to 30d detects a load value (hereinafter simply referred to as a load) received by coming into contact with object to be conveyed 2 due to the raising of plane portion 21, and outputs the load to calculation section 60 (see FIG. 4) to be described later. Sensors known in the art can be used as load sensors 30a to 30d, and thus, a detailed description thereof will be omitted.

Note that, in the present embodiment, a case where the shape of plane portion 21 and load sensors 30a to 30d as viewed from directly above is quadrangular has been described as an example, but the present disclosure is not limited thereto, and the shape thereof may be any other shape. In addition, the number and positions of the load sensors provided in plane portion 21 are not limited to those illustrated in FIG. 2.

In addition, in the present embodiment, a case where load sensors 30a to 30d are provided to protrude from plane portion 21 has been described as an example, but load sensors 30a to 30d may also be provided to be embedded in plane portion 21. However, in a case where load sensors 30a to 30d are embedded in plane portion 21 and the surface on the side of object to be conveyed 2, which comes into contact with load sensors 30a to 30d (hereinafter, the surface will be referred to as the contact surface), is not flat, any of load sensors 30a to 30d may not be able to sufficiently come into contact with the contact surface and may not be able to detect a load. On the other hand, when load sensors 30a to 30d protrude from plane portion 21, load sensors 30a to 30d can sufficiently come into contact with the contact surface without fail, and can detect a load more surely.

Next, the configuration of conveyance apparatus 1 will be described using FIG. 3. FIG. 3 is a block diagram illustrating the configuration of conveyance apparatus 1.

Although illustration is omitted, conveyance apparatus 1 includes, as hardware, for example, a central processing unit (CPU), a read only memory (ROM) that stores a computer program, a random access memory (RAM) that is a work memory, and the like. Operations of conveyance apparatus 1 (in particular, operations of calculation section 60 and control section 70) to be described later are implemented by the CPU reading out the computer program from the ROM and executing the computer program in the RAM.

As illustrated in FIG. 3, conveyance apparatus 1 includes wheels 10, lifting mechanism 20, load sensors 30a to 30d, wheel driving section 40, lifting mechanism driving section 50, calculation section 60, and control section 70. Since wheels 10, lifting mechanism 20, and load sensors 30a to 30d have already been described above, descriptions thereof will be omitted here.

Wheel driving section 40 is an apparatus that rotates wheels 10 in the forward direction or the rearward direction and steers wheels 10 in the rightward direction or the leftward direction.

Lifting mechanism driving section 50 is an apparatus that raises lifting mechanism 20 (plane portion 21) in the upward direction (the direction of arrow A in FIG. 1) or lowers lifting mechanism 20 (plane portion 21) in the downward direction (the direction of arrow B in FIG. 1).

Calculation section 60 performs various types of calculation processing. Details thereof will be described later.

Control section 70 performs various types of control processing on wheel driving section 40 and lifting mechanism driving section 50. Details thereof will be described later.

Next, operations of conveyance apparatus 1 will be described using FIG. 4. FIG. 4 is a flowchart illustrating a flow of operations of conveyance apparatus 1.

The flow illustrated in FIG. 4 starts from, for example, a state in which conveyance apparatus 1 is located at a position away from object to be conveyed 2 (for example, see FIG. 1).

First, control section 70 controls wheel driving section 40 to cause conveyance apparatus 1 to move below object to be conveyed 2 (step S1).

Thus, for example, conveyance apparatus 1 travels to directly below the lowest shelf (the shelf on which cargo 3 is disposed) of object to be conveyed 2 and stops. At this time, plane portion 21 in the most lowered state is in a state of being apart from and facing the lower surface of the lowest shelf (the back surface of the surface on which cargo 3 is disposed). Note that, since the processing in step S1 is a technique known in the art, a detailed description thereof will be omitted.

Next, control section 70 controls lifting mechanism driving section 50 to cause lifting mechanism 20 to be raised until all of load sensors 30a to 30d detect loads (step S2).

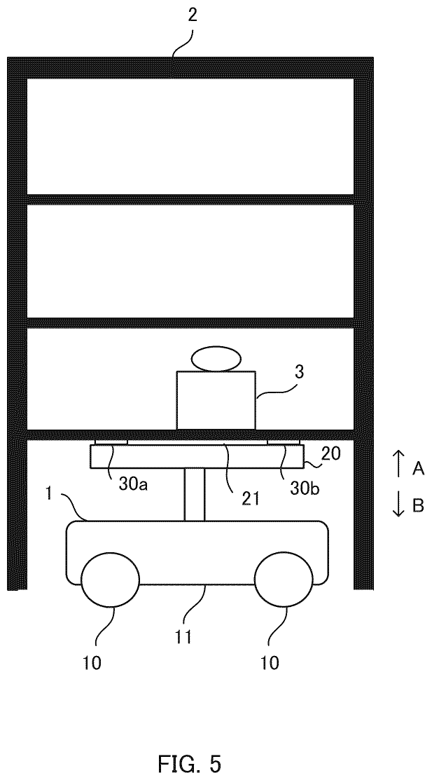

The state of conveyance apparatus 1 at this time is illustrated in FIG. 5. FIG. 5 is a side view schematically illustrating conveyance apparatus 1 and object to be conveyed 2, in the same manner as FIG. 1.

As illustrated in FIG. 5, lifting mechanism 20 (plane portion 21) is raised in the direction of arrow A as compared with the state in FIG. 1. At this time, load sensors 30a to 30d (illustration of load sensors 30c and 30d is omitted) are in contact with object to be conveyed 2 (specifically, the lower surface of the lowest shelf described above) and are slightly lifting object to be conveyed 2. With this, load detection is performed by load sensors 30a to 30d.

As described above, in the present embodiment, object to be conveyed 2 is slightly lifted before full-scale lifting for conveyance is executed, and the load detection is executed by all of load sensors 30a to 30d.

Next, calculation section 60 calculates the center-of-gravity position of object to be conveyed 2, based on a distribution of the detected loads (step S3).

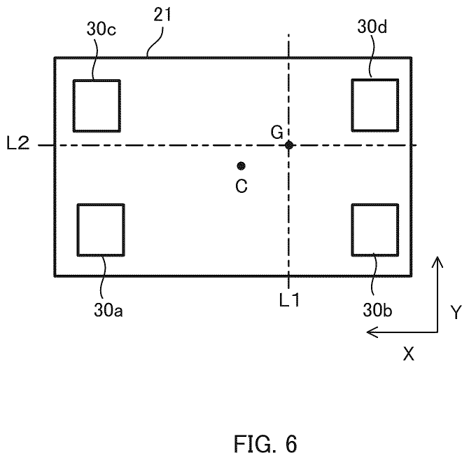

Here, a calculation example in step S3 will be described using FIG. 6. FIG. 6 is a top view schematically illustrating plane portion 21 in the same manner as FIG. 2. Center position C of plane portion 21, the length of plane portion 21 in the longitudinal direction (the X direction in FIG. 2), and the length of plane portion 21 in the lateral direction (the Y direction in FIG. 2), which are illustrated in FIG. 6, have values known to calculation section 60.

First, calculation section 60 calculates centroid line L1 along the Y direction based on center position C of plane portion 21, the length of plane portion 21 in the longitudinal direction, the sum of the load detected by load sensor 30a and the load detected by load sensor 30c, and the sum of the load detected by load sensor 30b and the load detected by load sensor 30d.

Next, calculation section 60 calculates centroid line L2 along the X direction based on center position C of plane portion 21, the length of plane portion 21 in the lateral direction, the sum of the load detected by load sensor 30a and the load detected by load sensor 30b, and the sum of the load detected by load sensor 30c and the load detected by load sensor 30d.

Then, calculation section 60 determines the intersection of centroid line L1 and centroid line L2 as center-of-gravity position G of object to be conveyed 2.

Note that, the center-of-gravity position of object to be conveyed 2 may also be determined by using a method known in the art other than the above-described calculation method.

Hereinafter, the flow of FIG. 4 will be described again.

Next, calculation section 60 calculates the two-point distance between center-of-gravity position G of object to be conveyed 2 and center position C of plane portion 21 (step S4).

Next, control section 70 controls lifting mechanism driving section 50 to cause lifting mechanism 20 to be lowered such that all of load sensors 30a to 30d are apart from object to be conveyed 2 (step S5).

At this time, control section 70 may cause the lowering of lifting mechanism 20 to stop at a point in time at which all of load sensors 30a to 30d no longer detect any load, or may cause lifting mechanism 20 to be lowered to the most lowered state regardless of whether any load is detected.

Next, control section 70 controls wheel driving section 40 to cause conveyance apparatus 1 to move, based on the calculated two-point distance, such that center position C of plane portion 21 and center-of-gravity position G of object to be conveyed 2 coincide with each other (step S6).

Thus, conveyance apparatus 1 moves to a position at which object to be conveyed 2 is liftable at calculated center-of-gravity position G.

Next, control section 70 controls lifting mechanism driving section 50 to cause lifting mechanism 20 to be raised such that object to be conveyed 2 is apart from the ground (step S7).

At this time, control section 70 causes lifting mechanism 20 to be raised such that the position of lifting mechanism 20 becomes higher than the position thereof when lifting mechanism 20 is raised in step S2. Thus, object to be conveyed 2 is in a state of being apart from the ground and being lifted by lifting mechanism 20 (plane portion 21).

Next, control section 70 controls wheel driving section 40 to cause conveyance apparatus 1 to move to a predetermined position in a state in which object to be conveyed 2 is lifted by lifting mechanism 20 (step S8).

The predetermined position is, for example, a position designated in advance by a user. Note that, since the processing in step S8 is a technique known in the art, a detailed description thereof will be omitted.

As described above, conveyance apparatus 1 in the present embodiment is a conveyance apparatus that includes lifting mechanism 20 raisable upward and lowerable downward, lifts object to be conveyed 2, by bringing lifting mechanism 20 into contact with object to be conveyed 2 and raising lifting mechanism 20, and moves in a state in which object to be conveyed 2 is lifted. The conveyance apparatus 1 includes: a plurality of load sensors 30a to 30d that is provided in lifting mechanism 20 and each detects a load received by coming into contact with object to be conveyed 2; calculation section 60 that calculates center-of-gravity position G of object to be conveyed 2, based on a distribution of the detected loads; and control section 70 that causes conveyance apparatus 1 to move to a position, at which object to be conveyed 2 is liftable at calculated center-of-gravity position

G, and causes lifting mechanism 20 to be raised.

In the conveyance apparatus in the related art, there is a problem in that an object to be conveyed is inclined or falls down in a case where the object to be conveyed is lifted at a position deviating from the center-of-gravity position thereof. This problem can be solved by configuring such that the center-of-gravity position of an object to be conveyed is grasped in advance and the object to be conveyed is lifted at the center-of-gravity position thereof.

However, in a case where the object to be conveyed is a product which allows one or more objects to be disposed at any position(s) and of which the center-of-gravity position varies depending on the number and position(s) of the object(s), it is difficult to grasp the center-of-gravity position of the product in advance, and thus, it is desired to solve the above problem even for such an object to be conveyed.

Accordingly, conveyance apparatus 1 in the present embodiment is configured, as in the features described above, such that center-of-gravity position G of object to be conveyed 2 is determined based on a distribution of detected loads before the lifting for conveyance is executed, and object to be conveyed 2 is lifted at center-of-gravity position G thereof. Thus, even in a case where the center-of-gravity position of an object to be conveyed is difficult to grasp in advance, it is possible to more surely prevent inclination or fall down of the object to be conveyed when the object to be conveyed is lifted.

Note that, the present disclosure is not limited to the description of the embodiment described above, and various variations can be made without departing from the gist of the present disclosure. Hereinafter, variations will be described.

### [Variation 1]

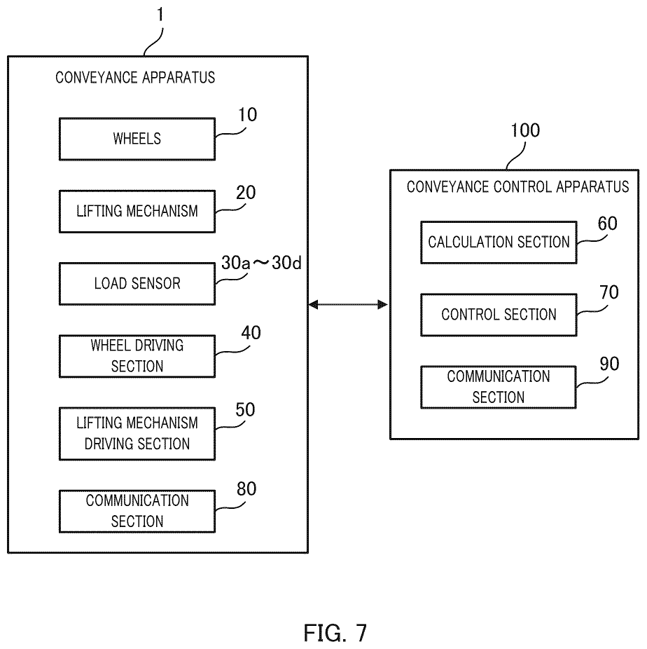

In the embodiment above, a case where conveyance apparatus 1 includes calculation section 60 and control section 70 and conveyance apparatus 1 itself controls the operations thereof has been described as an example, but the present disclosure is not limited thereto. For example, an apparatus separated from conveyance apparatus 1 may include calculation section 60 and control section 70, and the apparatus may control the operations of conveyance apparatus 1. This example will be described below using FIG. 7. FIG. 7 is a block diagram illustrating the configurations of conveyance apparatus 1 and conveyance control apparatus 100 in the present variation.

Conveyance apparatus 1 illustrated in FIG. 7 is different from conveyance apparatus 1 in FIG. 3 in that conveyance apparatus 1 illustrated in FIG. 7 does not include calculation section 60 and control section 70, but instead includes communication section 80. Note that, since the components other than communication section 80 in conveyance apparatus 1 have already been described in the embodiment, descriptions thereof will be omitted here.

Communication section 80 is an apparatus that transmits and receives information to and from communication section 90 of conveyance control apparatus 100 by using a radio communication method known in the art. Specifically, communication section 80 transmits load information indicating loads detected by load sensors 30a to 30d to conveyance control apparatus 100. In addition, communication section 80 receives control information (whose details will be described later) which is transmitted by conveyance control apparatus 100 and indicates a control instruction for conveyance apparatus 1, and outputs the control information to wheel driving section 40 and lifting mechanism driving section 50. Wheel driving section 40 and lifting mechanism driving section 50 then operate, based on the control information, wheels 10 and lifting mechanism 20, respectively.

Conveyance control apparatus 100 is an apparatus that is provided separately from conveyance apparatus 1 and controls the operations of conveyance apparatus 1. Although illustration is omitted, conveyance control apparatus 100 includes, as hardware, for example, a CPU, a ROM that stores a computer program, a RAM that is a work memory, and the like. Operations of conveyance control apparatus 100 (in particular, operations of calculation section 60 and control section 70) to be described later are implemented by the CPU reading out the computer program from the ROM and executing the computer program in the RAM.

As illustrated in FIG. 7, conveyance control apparatus 100 includes calculation section 60, control section 70, and communication section 90.

Communication section 90 is an apparatus that transmits and receives information to and from communication section 80 of conveyance apparatus 1 by using a radio communication method known in the art. Specifically, communication section 90 receives load information transmitted by conveyance apparatus 1. In addition, communication section 90 transmits control information (whose details will be described later) generated by control section 70 to conveyance apparatus 1.

The basic operations of calculation section 60 and control section 70 are the same as those in the embodiment. Hereinafter, operations of calculation section 60 and control section 70 in the present variation will be described in detail according to the flow of FIG. 4 described in the embodiment.

First, control section 70 generates first control information and causes the first control information to be transmitted from communication section 90 to conveyance apparatus 1. The first control information is information for moving conveyance apparatus 1 below object to be conveyed 2; and then raising lifting mechanism 20 until all of load sensors 30a to 30d detect loads.

Thereafter, at conveyance apparatus 1, communication section 80 receives the first control information and outputs the first control information to wheel driving section 40 and lifting mechanism driving section 50.

First, wheel driving section 40 operates wheels 10 based on the first control information. Thus, conveyance apparatus 1 moves below object to be conveyed 2.

Next, lifting mechanism driving section 50 raises lifting mechanism 20 based on the first control information, and stops the raising of lifting mechanism 20 when loads are detected by all of load sensors 30a to 30d.

Then, communication section 80 transmits load information indicating the loads detected by load sensors 30a to 30d to conveyance control apparatus 100.

At conveyance control apparatus 100, when communication section 80 receives the load information, calculation section 60 calculates center-of-gravity position G (see FIG. 6) of object to be conveyed 2, based on a distribution of the loads indicated by the load information.

Next, calculation section 60 calculates the two-point distance between center-of-gravity position G of object to be conveyed 2 and center position C of plane portion 21 (see FIG. 6).

Next, control section 70 generates second control information and causes the second control information to be transmitted from communication section 90 to conveyance apparatus 1. The second control information is information for lowering lifting mechanism 20 such that all of load sensors 30a to 30d are apart from object to be conveyed 2, next moving conveyance apparatus 1 to a position at which object to be conveyed 2 is liftable at calculated center-of-gravity position G (specifically, moving conveyance apparatus 1, based on the calculated two-point distance, such that center-of-gravity position G of object to be conveyed 2 and center position C of plane portion 21 coincide with each other), and next raising lifting mechanism 20 such that object to be conveyed 2 is apart from the ground. Note that, the second control information includes information indicating center position C of plane portion 21, center-of-gravity position G of object to be conveyed 2, and the two-point distance therebetween.

Next, control section 70 generates third control information and causes the third control information to be transmitted from communication section 90 to conveyance apparatus 1. The third control information is information for moving conveyance apparatus 1 to a predetermined position in a state in which lifting mechanism 20 is raised such that object to be conveyed 2 is apart from the ground. Note that, the third control information includes information indicating the predetermined position.

Thereafter, at conveyance apparatus 1, communication section 80 receives the second control information and the third control information and outputs the second control information and the third control information to wheel driving section 40 and lifting mechanism driving section 50.

First, lifting mechanism driving section 50 lowers lifting mechanism 20 based on the second control information such that all of load sensors 30a to 30d are apart from object to be conveyed 2. At this time, lifting mechanism driving section 50 may stop the lowering of lifting mechanism 20 at a point in time at which all of load sensors 30a to 30d no longer detect any load, or may lower lifting mechanism 20 to the most lowered state regardless of whether any load is detected.

Next, wheel driving section 40 operates wheels 10 based on the second control information. Thus, conveyance apparatus 1 moves to a position at which object to be conveyed 2 is liftable at center-of-gravity position G (specifically, a position at which center-of-gravity position G of object to be conveyed 2 and center position C of plane portion 21 coincide with each other).

Next, lifting mechanism driving section 50 raises lifting mechanism 20 based on the second control information such that object to be conveyed 2 is apart from the ground. At this time, lifting mechanism driving section 50 raises lifting mechanism 20 such that the position of lifting mechanism 20 becomes higher than the position thereof when lifting mechanism 20 is raised until all of load sensors 30a to 30d detects loads (see FIG. 5). Thus, object to be conveyed 2 is in a state of being apart from the ground and being lifted by lifting mechanism 20 (plane portion 21).

Next, wheel driving section 40 operates wheels 10 based on the third control information. Thus, conveyance apparatus 1 moves to the predetermined position in a state in which object to be conveyed 2 is lifted by lifting mechanism 20.

As described above, even in a configuration in which calculation section 60 and control section 70 are provided in conveyance control apparatus 100 separated from conveyance apparatus 1, the same working effects as those in the embodiment can be attained.

Note that, in the present variation, the second control information and the third control information have been described separately, but the content of the third control information may also be included in the second control information.

### [Variation 2]

In the embodiment, a case where object to be conveyed 2 is an instrument which allows one or more objects to be disposed at any position(s) and of which the center-of-gravity position varies depending on the number and position(s) of the object(s) has been described as an example, but the present disclosure is not limited thereto. Conveyance apparatus 1 described in the embodiment and conveyance control apparatus 100 described in Variation 1 are also capable of exerting the same working effects on an object to be conveyed of which the center-of-gravity position does not change (an object to be conveyed of which the center-of-gravity position can be grasped in advance).

Hence, conveyance apparatus 1 in the embodiment and conveyance control apparatus 100 in Variation 1 make it possible to prevent inclination or fall down of an object to be conveyed when the object to be conveyed is lifted, even for an object to be conveyed of which the center-of-gravity position can be grasped in advance or even for an object to be conveyed of which the center-of-gravity position is difficult to grasp in advance. That is, it is possible to more surely prevent inclination or fall down of an object to be conveyed when the object to be conveyed is lifted, regardless of the type of the object to be conveyed.

### INDUSTRIAL APPLICABILITY

The conveyance apparatus and the conveyance control apparatus in the present disclosure are useful for the entire technical field of lifting and conveying an object to be conveyed.

### REFERENCE SIGNS LIST

1 Conveyance apparatus
2 Object to be conveyed
3 Cargo
10 Wheel
11 Body portion
20 Lifting mechanism
21 Plane portion
30a, 30b, 30c, 30d Load sensor
40 Wheel driving section
50 Lifting mechanism driving section
60 Calculation section
70 Control section
80, 90 Communication section
100 Conveyance control apparatus

1. A conveyance apparatus that includes a lifting mechanism raisable upward and lowerable downward, lifts an object to be conveyed, by bringing the lifting mechanism into contact with the object to be conveyed and raising the lifting mechanism, and moves in a state in which the object to be conveyed is lifted, the conveyance apparatus comprising:
a plurality of load sensors that is provided in the lifting mechanism and each detects a load received by coming into contact with the object to be conveyed;
a calculation section that calculates a center-of-gravity position of the object to be conveyed, based on a distribution of a plurality of the loads that has been detected; and
a control section that causes the conveyance apparatus to move to a position and causes the lifting mechanism to be raised, the position being a position at which the object to be conveyed is liftable at the center-of-gravity position that has been calculated.

2. The conveyance apparatus according to claim 1, wherein:
the control section causes the conveyance apparatus to move below the object to be conveyed, and causes the lifting mechanism to be raised until all of the plurality of load sensors detect the plurality of loads,
the calculation section calculates the center-of-gravity position of the object to be conveyed, based on the distribution of the plurality of loads that has been detected, and calculates a two-point distance between the center-of-gravity position and a center position of the lifting mechanism, and
the control section
causes the lifting mechanism to be lowered such that the all of the plurality of load sensors are apart from the object to be conveyed,
causes the conveyance apparatus to move, based on the two-point distance that has been calculated, such that the center-of-gravity position and the center position coincide with each other, and
causes the lifting mechanism to be raised such that the object to be conveyed is apart from ground.

3. The conveyance apparatus according to claim 2, wherein:
the lifting mechanism includes a plane portion that faces the object to be conveyed when the object to be conveyed is lifted,
the plurality of load sensors is disposed to be apart from each other in the plane portion, and
the center position is a center position of the plane portion.

4. The conveyance apparatus according to claim 3, wherein
the plurality of load sensors is provided to protrude from the plane portion.

5. The conveyance apparatus according to claim 1, wherein
the object to be conveyed is an instrument which allows one or more objects to be disposed at any position or positions and of which a center-of-gravity position varies depending on a number of the one or more objects to be disposed and the position or positions of the one or more objects to be disposed.

6. A conveyance control apparatus that is provided separately from a conveyance apparatus and controls the conveyance apparatus, wherein the conveyance apparatus includes a lifting mechanism raisable upward and lowerable downward, lifts an object to be conveyed, by bringing the lifting mechanism into contact with the object to be conveyed and raising the lifting mechanism, and moves in a state in which the object to be conveyed is lifted, the conveyance control apparatus comprising:
a communication section that receives load information from the conveyance apparatus and transmits control information to the conveyance apparatus, the load information being information indicating a plurality of loads detected by a plurality of load sensors provided in the lifting mechanism when the plurality of load sensors comes into contact with the object to be conveyed, the control information being information indicating a control instruction for the conveyance apparatus;
a calculation section that calculates a center-of-gravity position of the object to be conveyed, based on a distribution of the plurality of loads that has been detected; and
a control section that generates the control information for moving the conveyance apparatus to a position and raising the lifting mechanism, the position being a position at which the object to be conveyed is liftable at the center-of-gravity position that has been calculated.

7. The conveyance control apparatus according to claim 6, wherein:
the control section generates the control information for moving the conveyance apparatus below the object to be conveyed, and raising the lifting mechanism until all of the plurality of load sensors detect the plurality of loads, and causes the control information to be transmitted from the communication section to the conveyance apparatus,
the calculation section calculates the center-of-gravity position of the object to be conveyed, based on the distribution of the plurality of loads indicated by the load information received by the communication section, and calculates a two-point distance between the center-of-gravity position and a center position of the lifting mechanism, and
the control section generates the control information for lowering the lifting mechanism such that the all of the plurality of load sensors are apart from the object to be conveyed, moving the conveyance apparatus, based on the two-point distance that has been calculated, such that the center-of-gravity position and the center position coincide with each other, and raising the lifting mechanism such that the object to be conveyed is apart from ground, and causes the control information to be transmitted from the communication section to the conveyance apparatus.

8. The conveyance control apparatus according to claim 7, wherein:
the lifting mechanism includes a plane portion that faces the object to be conveyed when the object to be conveyed is lifted,
the plurality of load sensors is disposed to be apart from each other in the plane portion, and
the center position is a center position of the plane portion.

9. The conveyance control apparatus according to claim 8, wherein
the plurality of load sensors is provided to protrude from the plane portion.

10. The conveyance control apparatus according to claim 6, wherein
the object to be conveyed is an instrument which allows one or more objects to be disposed at any position or positions and of which a center-of-gravity position varies depending on a number of the one or more objects to be disposed and the position or positions of the one or more objects to be disposed.
